(19) United States
(12) Patent Application Publication
(10) Pub. No.: US 2008/0170758 A1
(43) Pub. Date: Jul. 17, 2008

(54) Method and system for selecting and allocating high confidence biometric data

(75) Inventors: Andrew H. Johnson, New Brighton, MN (US); Bruce W. Anderson, Andover, MN (US); Edward L. Cochran, Minneapolis, MN (US); Thomas R. Markham, Fridley, MN (US)

Correspondence Address: Intellectual Property;Honeywell International Inc., 101 Columbia Rd., P.O. Box 2245, Morristown, NJ, 07962, US

(73) Assignee: Honeywell International Inc.

(21) Appl. No.: 11/703,369

(22) Filed: Feb. 7, 2007

Related U.S. Application Data
(60) Provisional application No. 60/884,796, filed on Jan. 12, 2007.

(51) Int. Cl. G06K 9/40

(52) U.S. Cl. 382/115

(57) ABSTRACT

A method and system for selecting and allocating high confidence biometric data. A combination of presented identification information along with gathered biometric data are associated with an entity separated by a sensor trigger. For example, presenting a driver's license in addition to automated gathering and identification of face, iris, voice, or any other combination of biometrics can be implemented in the context of gathering and selecting biometric data. Such a method and system solves the problem of harvesting sensor data from disparate sources together to form a more strongly identified individual user profile with appropriate related identifying information.

### CROSS-REFERENCE TO RELATED APPLICATION

This patent application claims priority under 35 U.S.C. § 119(e) to U.S. Provisional Patent Application Ser. No. 60/884,796 entitled “Method and System for Selecting and Allocating High Confidence Biometric Data,” which was filed on Jan. 12, 2007, the disclosure of which is incorporated herein by reference in its entirety.

### TECHNICAL FIELD

Embodiments are generally related to data-processing devices and techniques. Embodiments are also related to screening systems and methods. Embodiments are additionally related to biometric identification techniques.

### BACKGROUND

The expansion of terrorism throughout the world has resulted in increased hazards to many cultures, particularly relatively free and open societies such as the United States of America. In such an open society, it is relatively easy to do a great deal of damage, as evidenced by “car bombs,” i.e., automobiles or other vehicles loaded with explosives and detonated beneath or near a building structure.

Such motor vehicles are also used for concealing and smuggling various types of weaponry and contraband (e.g., drugs, etc.). Authorities are well aware of the potential hazards of such concealed articles and materials, and a number of automated inspection devices employing different principles of operation have been developed in response. Nevertheless, the inspection of every vehicle passing a given point or location is generally impractical in most instances. This is particularly true for large scale events, e.g. major sporting events, public events at military bases, facilities providing daily employment to large numbers of workers and staff, etc.

Presently, inspection devices employing one principle of operation are utilized for detecting explosives, and another principle or principles is/are used for the detection of concealed weapons. These various detection devices are independent of one another and must be used separately in any given inspection station or location. In many instances, authorities simply cannot provide the number of personnel required to perform all of the inspections necessary to completely inspect all vehicles passing through a given checkpoint. Even if it were possible to provide sufficient personnel, this would clearly add considerably to the time involved in a detailed inspection of every vehicle passing through a given inspection point.

It is therefore believed that one solution to these problems involves the design and implementation of a self-screening system for permitting vehicles to pass through security gates in order to gain access to a facility or area. It is further believed that an additional solution involves the use of biometrics.

Biometrics can generally be defined as the science of utilizing unique physical or behavioral personal characteristics to verify the identity of an individual. Biometric authentication systems are typically combined with hardware and software systems for automated biometric verification or identification. Biometric authentication systems receive a biometric input, such as a fingerprint or a voice sample, from a user. This biometric input is typically compared against a prerecorded template containing biometric data associated with the user to determine whether to grant the user access to a service on the host system.

A biometric security access system can thus provide substantially secure access and does not require a password or access code. A biometric identification system accepts unique biometric information from a user and identifies the user by matching the information against information belonging to registered users of the system. One such biometric system is a fingerprint recognition system.

In a fingerprint biometric system input transducer or sensor, the finger under investigation is usually pressed against a flat surface, such as a side of a glass plate; the ridge and valley pattern of the finger tip is sensed by a sensing means such as an interrogating light beam. In order to capture an image of a fingerprint, a system may be prompted through user entry that a fingertip is in place for image capture. Another method of identifying fingerprints is to capture images continuously and to analyze each image to determine the presence of biometric information such as a fingerprint.

Various optical devices are known which employ prisms upon which a finger whose print is to be identified is placed. The prism has a first surface upon which a finger is placed, a second surface disposed at an acute angle to the first surface through which the fingerprint is viewed and a third illumination surface through which light is directed into the prism. In some cases, the illumination surface is at an acute angle to the first surface. In other cases, the illumination surface may be parallel to the first surface. Fingerprint identification devices of this nature are generally used to control the building-access or information-access of individuals to buildings, rooms, and devices such as computer terminals.

Before the advent of computers and imaging devices, research was conducted into fingerprint characterization and identification. Today, much of the research focus in biometrics has been directed toward improving the input transducer and the quality of the biometric input data. Fingerprint characterization is thus generally well known and can involve many aspects of fingerprint analysis.

Another biometric authorization technique involves the use of biometric facial data based on a scanned face. Biometric face recognition works by using a computer to analyze a subject's facial structure. Face recognition software takes a number of points and measurements, including the distances between key characteristics such as eyes, nose and mouth, angles of key features such as the jaw and forehead, and lengths of various portions of the face. Using all of this information, the program creates a unique template incorporating all of the numerical data. This template may then be compared to enormous databases of facial images to identify the subject. Good biometric software then produces a number of potential matches, rating each based on a numeric score of how similar the match is. When multiple images are used, the accuracy of biometric readings increases greatly, a fact which has provoked the assembly of massive databases, particularly on key figures such as terrorists.

One of the primary problems inherent with gather multiple biometric data is the problem of harvesting sensor data from disparate sources. Errors can be produced during such gathering processes, which can degrade the reliability of the biometric match during, for example, a security screening operation. It is therefore believed that a solution to this problem involves the implementation of a unique method and system of selecting and allocating “high confidence” biometric data, which is described in greater detail herein.

### BRIEF SUMMARY

The following summary is provided to facilitate an understanding of some of the innovative features unique to the embodiments and is not intended to be a full description. A full appreciation of the various aspects of the embodiments disclosed can be gained by taking the entire specification, claims, drawings, and abstract as a whole.

It is, therefore, one aspect of the present invention to provide for improved data-processing techniques and devices.

It is another aspect of the present invention to provide for an improved biometric screening system and method.

It is a further aspect of the present invention to provide for method and system for selecting and allocating high confidence biometric data.

The aforementioned aspects of the invention and other objectives and advantages can now be achieved as described herein. A method and system are disclosed for selecting and allocating high confidence biometric data. A combination of presented identification information along with gathered biometric data are associated with an entity separated by a sensor trigger. For example, presenting a driver's license in addition to automated gathering and identification of face, iris, voice, or any other combination of biometrics can be implemented in the context of gathering and selecting biometric data. Such a method and system solves the problem of harvesting sensor data from disparate sources together to form a more strongly identified individual user profile with appropriate related identifying information.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the principles of the disclosed embodiments.

FIG. 1 illustrates a block diagram of a data-processing apparatus, which can be adapted for use in implementing a preferred embodiment;

FIG. 2 illustrates a vehicle gate management system that can be implemented in accordance with an alternative embodiment;

FIG. 3 illustrates a kiosk and associated security gate system components, which can be implemented in accordance with an alternative embodiment; and

FIG. 4 illustrates a flow chart of operations illustrating logical operational steps for implementing a method for selecting and allocating high confidence biometric data in accordance with a preferred embodiment.

### DETAILED DESCRIPTION

The particular values and configurations discussed in these non-limiting examples can be varied and are cited merely to illustrate at least one embodiment and are not intended to limit the scope of the invention.

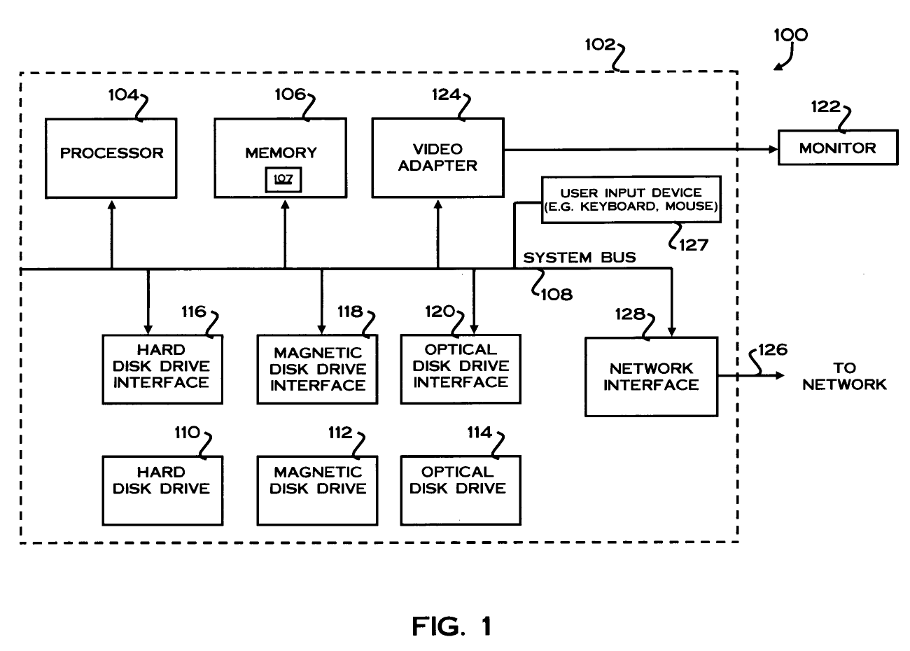

FIG. 1 illustrates a block diagram of a data-processing apparatus 100, which can be utilized in accordance with a preferred embodiment. Data-processing apparatus 100 (e.g., a computer) can be utilized in the context of the vehicle screening system 200 disclosed in further detail here. Data-processing apparatus 100 can be configured to include a general purpose computing device, such as a computer 102. The computer 102 includes a processing unit 104, a memory 106, and a system bus 108 that operatively couples the various system components to the processing unit 104. One or more processing units 104 operate as either a single central processing unit (CPU) or a parallel processing environment.

The data-processing apparatus 100 further includes one or more data storage devices for storing and reading program and other data. Examples of such data storage devices include a hard disk drive 110 for reading from and writing to a hard disk (not shown), a magnetic disk drive 112 for reading from or writing to a removable magnetic disk (not shown), and an optical disc drive 114 for reading from or writing to a removable optical disc (not shown), such as a CD-ROM or other optical medium. A monitor 122 is connected to the system bus 108 through an adapter 124 or other interface. Additionally, the data-processing apparatus 100 can include other peripheral output devices (not shown), such as speakers and printers. Additionally, a user input device 127 such as a keyboard and/or mouse can be connected to system bus 108 in order to permit users to input data, commands and instructions to data-processing apparatus 100.

The hard disk drive 110, magnetic disk drive 112, and optical disc drive 114 are connected to the system bus 108 by a hard disk drive interface 116, a magnetic disk drive interface 118, and an optical disc drive interface 120, respectively. These drives and their associated computer-readable media provide nonvolatile storage of computer-readable instructions, data structures, program modules, and other data for use by the data-processing apparatus 100. Note that such computer-readable instructions, data structures, program modules, and other data can be implemented as a module 107.

Note that the embodiments disclosed herein can be implemented in the context of a host operating system and one or more module(s) 107. In the computer programming arts, a software module can be typically implemented as a collection of routines and/or data structures that perform particular tasks or implement a particular abstract data type.

Software modules generally comprise instruction media storable within a memory location of a data-processing apparatus and are typically composed of two parts. First, a software module may list the constants, data types, variable, routines and the like that can be accessed by other modules or routines. Second, a software module can be configured as an implementation, which can be private (i.e., accessible perhaps only to the module), and that contains the source code that actually implements the routines or subroutines upon which the module is based. The term module, as utilized herein can therefore refer to software modules or implementations thereof. Such modules can be utilized separately or together to form a program product that can be implemented through signal-bearing media, including transmission media and recordable media.

It is important to note that, although the embodiments are described in the context of a fully functional data-processing apparatus such as data-processing apparatus 100, those skilled in the art will appreciate that the mechanisms of the present invention are capable of being distributed as a program product in a variety of forms, and that the present invention applies equally regardless of the particular type of signal-bearing media utilized to actually carry out the distribution. Examples of signal bearing media include, but are not limited to, recordable-type media such as floppy disks or CD ROMs and transmission-type media such as analogue or digital communications links.

Any type of computer-readable media that can store data that is accessible by a computer, such as magnetic cassettes, flash memory cards, digital versatile discs (DVDs), Bernoulli cartridges, random access memories (RAMs), and read only memories (ROMS) can be used in connection with the embodiments.

A number of program modules can be stored or encoded in a machine readable medium such as the hard disk drive 110, the, magnetic disk drive 114, the optical disc drive 114, ROM, RAM, etc or an electrical signal such as an electronic data stream received through a communications channel. These program modules can include an operating system, one or more application programs, other program modules, and program data.

The data-processing apparatus 100 can operate in a networked environment using logical connections to one or more remote computers (not shown). These logical connections are implemented using a communication device coupled to or integral with the data-processing apparatus 100. The data sequence to be analyzed can reside on a remote computer in the networked environment. The remote computer can be another computer, a server, a router, a network PC, a client, or a peer device or other common network node. FIG. 1 depicts the logical connection as a network connection 126 interfacing with the data-processing apparatus 100 through a network interface 128. Such networking environments are commonplace in office networks, enterprise-wide computer networks, intranets, and the Internet, which are all types of networks. It will be appreciated by those skilled in the art that the network connections shown are provided by way of example and that other means of and communications devices for establishing a communications link between the computers can be used.

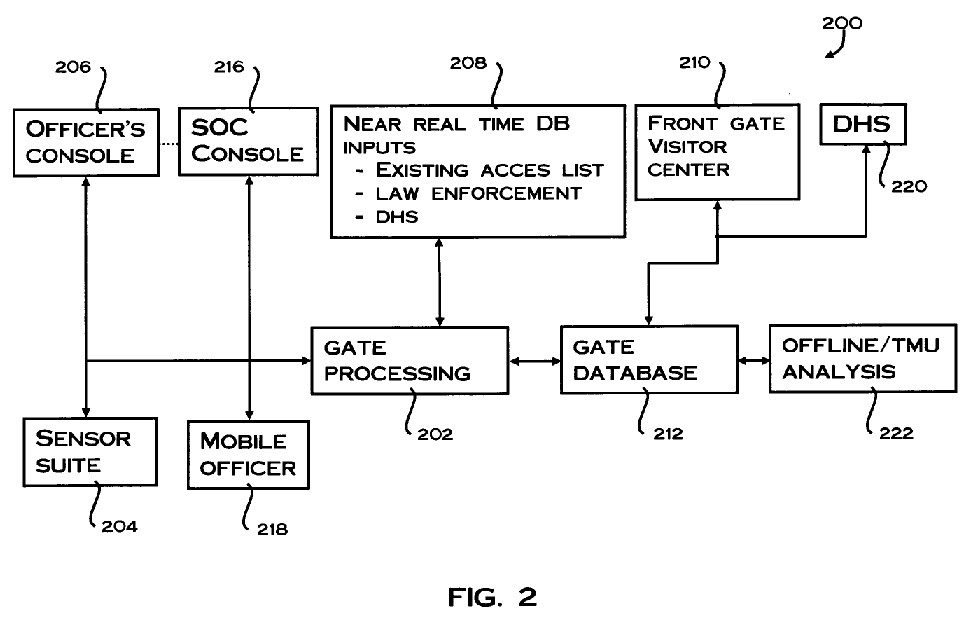

FIG. 2 illustrates a vehicle gate management system 200 that can be implemented in accordance with an alternative embodiment. System 200 represents one possible example of a security screening system in which a preferred embodiment may be implemented. It can be appreciated, of course, that other types of screening systems may also be utilized depending upon design considerations. System 200 includes the officer console 206, which provides the human/computer interface for officers. Officer console 206 includes live audio, live video, a database interface and status information. The interface also provides controls for the officer allowing them to control the Pan Tilt Zoom (PTZ) camera, mute their microphone, query the database and enter notes into the database.

System 200 additionally includes a mobile officer module 218, which can provide a limited subset of the officer's console 206 to mobile (in vehicle or on foot) officers. The mobile officer module 218 is designed to provide information over a wireless link. Module 218 can be implemented as a software module such as module 107 described earlier and/or in association with a mobile device such as, for example, a Personal Digital Assistant (PDA), cellular telephone, and/or other wireless communications devices, depending upon design considerations. System 200 also includes an SOC (Security Operations Center) console 216, which can communicate with the officer's console 206 and the mobile officer 2618. The SOC console 216 provides near real time support to the officers. The SOC console 216 can initiate database queries, control cameras and perform similar functions to support officers at the gate and mobile officers. The sensor suite 204 includes one or more sensors, which are essentially the “eyes” and “ears” of the officer, who is typically located at a guard booth. The sensor suite 204 receives camera control commands from the officer's console. Sensor suite 204 also collects audio, video, keypad input, driver's license data and license plate number from the vehicle.

The gate processing module 202 supports real time queries, analysis and matching to support officers at the gate. The gate processing module 202 can receive inputs from the sensor suite 204, interface to multiple databases and process real time events. The gate database 212, which communicates with the gate processing module 202, constitutes a database that is controlled by the system 200 and contains data collected by the gate sensors, input by officers and acquired from sources outside of the gate system 200. This information may be shared with other related systems. System 200 also includes near real-time database inputs 208. This feature permits the system 200 to make queries to systems/databases, which provide support to the gate management system 200. Examples include visitor control center SSN authorizations, driver's license databases, vehicle registration information, National Crime Information Center (NCIC) and watch lists.

The front gate visitor center 210 is implemented so that the system 200 shares information with the visitor center 210. That is, the visitor center 210 can receive near real time information from the gate on persons entering the visitor center 210. The system 200 also allows the visitor center 210 to update some elements of the front gate database. 212 (e.g. flags or notes if this visitor returns. System 200 can also be configured to include a TMU (Threat Management Unit) 222. The system 200 shares information with the TMU and the TMU receives updates from the front gate database 212. The TMU is also allowed to update some elements of the front gate database. The TMU 222 may copy the front gate database information into a TMU controlled database so that the TMU may perform analysis and data mining. Finally, system 200 can communicate with the DHS (Department of Homeland Security) 220. The DHS 220 can collect data from multiple gates, facilities and organizations, and can also provide offline analysis and data mining.

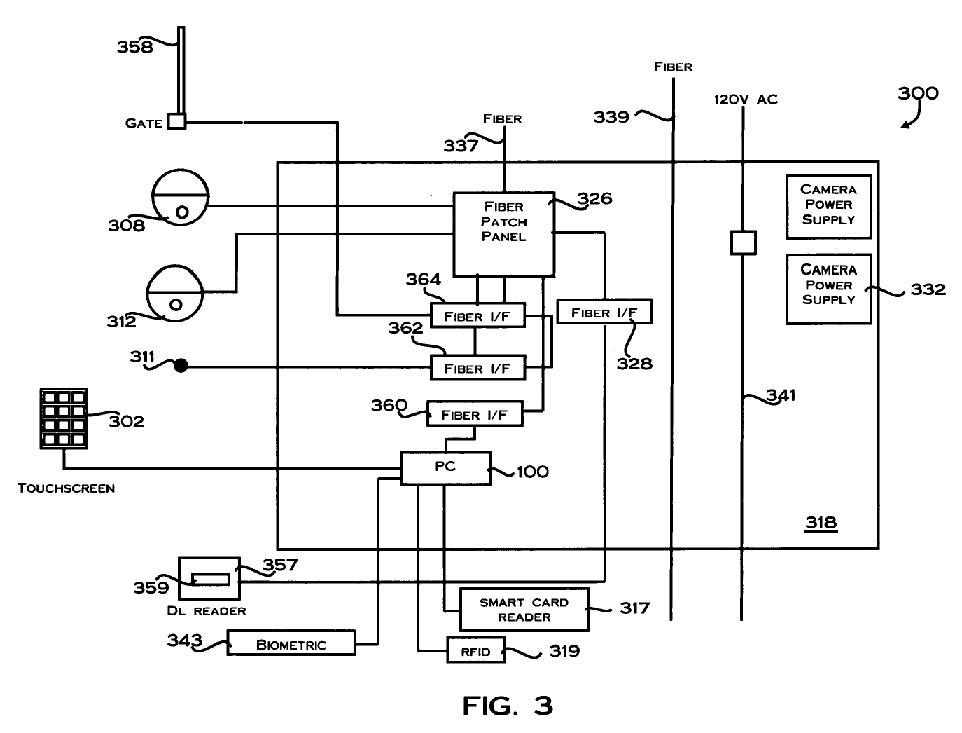

FIG. 3 illustrates an electronic drive-up kiosk 318 and associated security gate system components, which can be implemented in accordance with an alternative embodiment. Kiosk 318 depicted in FIG. 3 can be implemented as the kiosk 318 depicted in FIG. 27. In general, kiosk 318 is associated with a gate 358, which when raised permits a vehicle occupant to drive his or vehicle into a secured facility. Kiosk 318 includes a microphone 311 or other audio component that is connected to a Fiber I/F unit 362 that is connected to a fiber patch panel 326. The microphone 311 can be used for speech identification. A vehicle occupant in an automobile can speak into the microphone 311 to provide his or her voice for speech verification purposes. Kiosk 318 also includes an officer's camera 312 that is connected to the fiber patch panel 326. A face camera 308 is also provided as a part of kiosk 318. The face camera 308 is also generally connected to the fiber patch panel 326. The face camera 308 can be implemented in the context of a biometric scanner. For example, face camera 308 may be utilized to biometrically scan a vehicle occupant's face including iris for biometric facial and/or iris identification. A biometric reader 343 may actually be connected directly to the data-processing apparatus 100 in order to permit the vehicle occupant to enter particular biometric data, such as, for example, fingerprints, and/or other biometric input data for screening purposes.

A Fiber I/F unit 360 can be connected to the fiber patch panel 326 and to the data processing apparatus 100 depicted in FIG. 1. The gate 358 is generally connected to a Fiber I/F unit 364, which in turn is connected to the fiber patch panel 326. Note that the data-processing apparatus 100 or another type of computer can be utilized in association with the configuration depicted in FIG. 3. A DL Reader 357 having a reader slot 359 is connected to the data-processing apparatus 100, along with a touchscreen 302. Note that the touchscreen is a display overlay, which possesses the ability to display and receive information on the same screen. The effect of such overlays allows a display to be used as an input device, removing the keyboard and/or the mouse as the primary input device for interacting with the display's content. Such displays can be attached to computers or, as terminals, to networks.

Note that the DL reader 357 is a barcode reader that can read a two-dimensional bar code associated with a user identification card that belongs to a vehicle occupant. Note that although reader 357 is depicted in FIG. 3, it can be appreciated that the system and method described herein can also utilizes reader devices that rely on Radio Frequency Identification (RFID) such as, for example, an RFID reader 319. Near field communications and smartcard technologies which use radio frequency instead of optical means to communicate information can also be employed. For example, a vehicle occupant may possess a card having an RFID tag that can be automatically scanned by a wireless RFID reader 319 associated with the kiosk 318 in order to assist in verifying the identity of the vehicle occupant. Similarly, the identification card belong to the vehicle occupant can be, for example, a smart card and a smart card reader 317 may be employed by kiosk 318 instead of and/or in addition to reader 357. The DL reader 359, the biometric reader 343, the RFID reader 319 and the smart card reader 317 constitute a few examples of reader devices for extracting particular identification data associated with the vehicle occupant.

Kiosk 318 additionally includes two lines 2939 and 2941 which can electrically or optically connect to the processing and display elements of the system 300. A fiber line 337 is generally connected to the fiber patch panel 326. Kiosk 318 also includes one or more camera power supplies 330 and 332. Additionally, a 120 V AC line 341 and an additional fiber line 339 may communicate electrically with the kiosk 318 and its various components. A fiber I/F 328 is also generally provided between the fiber patch panel 326 and the DL reader 357.

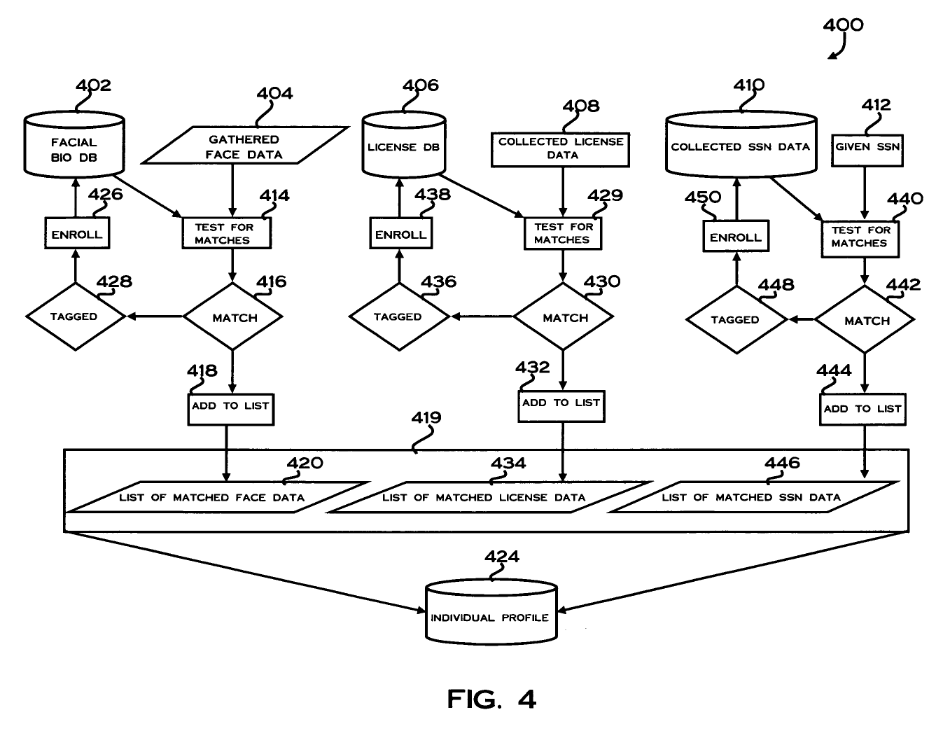

FIG. 4 illustrates a flow chart of operations illustrating logical operational steps for implementing a method 400 for selecting and allocating high confidence biometric data in accordance with a preferred embodiment. Note that the logical operational steps of method 400 can be provided as instruction media in the context of a software module, such as, for example, module 107 described earlier with respect to data-processing apparatus 100. The method 400 depicted in FIG. 4 solves the problem of harvesting sensor data from disparate sources together to form a more strongly identified individual with appropriate related information. A combination of presented identification data along with gathered biometric data can be associated with an entity separated by a sensor trigger. For example, presenting a driver's license in addition to automated gathering and identification of face, iris, voice or another other combination of biometrics can be implemented via the method 400 depicted in FIG. 4.

Method 400 generally includes a facial biometric database 402, a license database 406, and an identification database 410. The facial biometric database 402 contains facial biometric data. The license database 402 stores license plate and/or driver's license data. The identification database 410 includes identification data such as, for example, social security numbers and/or other identification numbers associated with individuals. As indicated at block 404, an operation can be performed in which biometric face data is gathered. Next, as indicated at block 414, an operation is performed to test for matches of biometric facial data. Thereafter, as indicated at block 416, if no match is performed then a tagging operation as indicated at block 428 is performed. Assuming the tagging operation is completed, then the biometric data obtained and/or gathered from a particular individual (e.g., a vehicle occupant) is enrolled as indicated at block 426 in the facial biometric database 402. If there is a match, as indicated at block 416, then the gathered biometric facial data is added directly to a list of matched facial data as indicated at blocks 418 and 420.

A similar process occurs with respect to collected license data, as indicated by the operation depicted at block 408. A test is performed to look for matches, as indicated at block 429. If no match occurs, as indicated at block 430 then a tagging operation is performed as indicated at block 436 and if a “yes” response occurs, then the collected license data is enrolled, as indicated at block 438, in the license database 406. Assuming no match occurs, as indicated at block 430, then as depicted at blocks 432 and 434, the license data is added to the list of matched license data.

Regarding identification (e.g., SSN data), the collection operation is depicted at block 412. Thereafter, as depicted at block 440, a test is performed to search for matches. Assuming that no match is found as indicated at block 442, then a tagging operation is performed as depicted at block 448. Assuming a “yes” response to the tagging operation occurs, then as indicated at blocks 450 and 410, the vehicle occupant and/or identification information associated with the vehicle occupant, is enrolled in the collected identification database 410. Assuming a match does occur, as indicated at block 442, then as indicated at blocks 444 and 446, the identification information is added to a list of matched identification data. The list 420 of matched biometric facial data, along with the list 434 of matched license data and/or the list 446 of matched identification data can be processed as indicated by block 419 for compilation of an individual profile 424 as indicated at block 424.

Method 400 thus permits a combination of presented identification information along with gathered biometric data to be associated with an entity and separated by a sensor trigger. For example, presenting a driver's license, as indicated by the operation illustrated at block 408 in addition to automated gathering and identification of face, iris, voice or any other combination of biometrics can solve the problem of harvesting sensor data from disparate sources and provide for enhanced security screening operations. Note that although the method 400 depicted in FIG. 4 refers to the use of facial biometric data gathering operations, it can be appreciated that a variety of other biometric data (e.g., iris, fingerprints, voice, etc.) may be gathered in the same general manner and for the same screening purposes. The biometric reader 343 and the microphone 211 depicted in FIG. 3 can be used, for example, in association with the method 400 to gather biometric data.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of selecting and allocating high-confidence biometric data, comprising:
prompting a user to input to an authentication system, at least one biometric attribute and at least one identifying indicator associated with said user; and
analyzing a combination of said at least one biometric attribute input by said user and said at least one identifying indicator associated with said user in order to form an enhanced user profile of said user based on data collected from disparate sources and thereby authenticating and validate said user.

2. The method of claim 1 wherein said at least one biometric attribute comprises facial biometric data associated with said user.

3. The method of claim 1 wherein said at least one biometric attribute comprises iris biometric data associated with said user.

4. The method of claim 1 wherein said at least one biometric attribute comprises voice biometric data associated with said user.

5. The method of claim 1 wherein analyzing a combination of said at least one biometric attribute input by said user and said at least one identifying indicator associated with said user in order to form an enhanced user profile of said user based on data collected from disparate sources and thereby authenticating and validate said user, further comprises:
comparing said at least one biometric attribute provided by said user to a database of biometric data to determine if said user has been previously authenticated.

6. The method of claim 5 wherein analyzing a combination of said at least one biometric attribute input by said user and said at least one identifying indicator associated with said user in order to form an enhanced user profile of said user based on data collected from disparate sources and thereby authenticating and validate said user, further comprises:
automatically enrolling said user profile in said biometric database if said user has not been previously authenticated.

7. The method of claim 1 wherein said at least one identifying indicator associated with said user comprises a SSN (Social Security Number) of said user.

8. The method of claim 1 wherein said at least one identifying indicator associated with said user comprises driver's license data associated with said user.

9. A method of selecting and allocating high-confidence biometric data, comprising:
prompting a user to input to an authentication system, at least one biometric attribute and at least one identifying indicator associated with said user; and
analyzing a combination of said at least one biometric attribute input by said user and said at least one identifying indicator associated with said user; and
comparing said at least one biometric attribute provided by said user to a database of biometric data to determine if said user has been previously authenticated in order to form an enhanced user profile of said user based on data collected from disparate sources and thereby authenticating and validate said user.

10. The method of claim 10 wherein analyzing a combination of said at least one biometric attribute input by said user and said at least one identifying indicator associated with said user in order to form an enhanced user profile of said user based on data collected from disparate sources and thereby authenticating and validate said user, further comprises:
automatically enrolling said user profile in said biometric database if said user has not been previously authenticated.

11. The method of claim 10 wherein said at least one biometric attribute comprises facial biometric data associated with said user.

12. The method of claim 10 wherein said at least one biometric attribute comprises iris biometric data associated with said user.

13. The method of claim 10 wherein said at least one biometric attribute comprises voice biometric data associated with said user.

14. The method of claim 10 wherein said at least one identifying indicator associated with said user comprises a SSN (Social Security Number) of said user.

15. The method of claim 10 wherein said at least one identifying indicator associated with said user comprises driver's license data associated with said user.

16. A system for selecting and allocating high-confidence biometric data, comprising:
a data-processing apparatus;
a module executed by said data-processing apparatus, said module and said data-processing apparatus being operable in combination with one another to:
prompt a user to input to an authentication system, at least one biometric attribute and at least one identifying indicator associated with said user; and
analyze a combination of said at least one biometric attribute input by said user and said at least one identifying indicator associated with said user in order to form an enhanced user profile of said user based on data collected from disparate sources and thereby authenticating and validate said user.

17. The system of claim 16 wherein said module and said data-processing apparatus are further operable in combination with one another to:
collect said at least one biometric attribute in response to a particular user input; and
collect said at least one identifying indicator associated with said user in response to a particular user input.

18. The system of claim 16 wherein said module and said data-processing apparatus are further operable in combination with one another to:
compare said at least one biometric attribute provided by said user to a database of biometric data to determine if said user has been previously authenticated.

19. The system of claim 16 wherein said module and said data-processing apparatus are further operable in combination with one another to:
automatically enroll said user profile in said biometric database if said user has not been previously authenticated.

20. The system of claim 16 wherein said at least one identifying indicator associated with said user comprises at least one of the following types of information: SSN (Social Security Number) of said user and/or driver's license data associated with said user.
